(19) United States
(12) Patent Application Publication
(10) Pub. No.: US 2017/0110041 A1
(43) Pub. Date: Apr. 20, 2017

(54) DISPLAY PANEL

(71) Applicant: InnoLux Corporation, Miao-Li County (TW)

(72) Inventor: Hirofumi WATSUDA, Miao-Li County (TW)

(21) Appl. No.: 14/882,589

(22) Filed: Oct. 14, 2015

(51) Int. Cl. G09G 3/20

(52) U.S. Cl. CPC G09G 3/20; G09G 2300/0426; G09G 2310/08; G09G 2310/0275; G09G 2310/0297; G09G 2330/028

(57) ABSTRACT

A display panel comprises an open area, a data driver, a first de-multiplexer having an input terminal and a plurality of output terminals, a second de-multiplexer having a input terminal and a plurality of output terminals, a first data line, a second data line, and a third data line. The first de-multiplexer and the second de-multiplexer are located at opposite side of the open area, the first de-multiplexer and the second de-multiplexer are connected to the data driver through a first data output terminal of the data driver, and the first de-multiplexer is located between the data driver and the open area. The first data line is connected to one of the output terminals of the first de-multiplexer, the second data line is connected to one of the output terminals of the second de-multiplexer, and the third data line is connected to the input terminal of the second de-multiplexer.

### BACKGROUND OF THE INVENTION

1. Field of the Invention

The present invention relates to the technical field of display panels and, more particularly, to a perforated display panel which has an open area within a display area.

2. Description of Related Art

According to the fast advancement of various display devices, there are many application types of the display panels. A perforated display which has an open area within a display area (active area) is one important variation. The perforated display panel can be used in smart watch application, automotive application, astronavigation application, and so on.

For perforated display panel, extra driver pins, extra connecting wiring, extra de-multiplexers, and extra peripheral space are needed. The need of extra space is unsatisfactory as the panel size cannot be minimized.

Therefore, it is desirable to provide an improved display panel system to mitigate and/or obviate the aforementioned problems.

### SUMMARY OF SOME EMBODIMENTS OF THE INVENTION

A display panel is described, which has the bridge lines (BDLs) wired around a display open area. The bridge lines can be data transmission lines for a second de-multiplexer which is located at the far side of a data driver in a perforated display device. With the technology of the present invention, wiring space impact on the panel frame area can be eliminated in comparison with the prior art, and the order of data signal output can be the same as that in a non-perforated display case, thereby providing a narrow-border display panel.

According to one embodiment of the disclosure, there is provided a display panel, which comprises an open area, a data driver, a first de-multiplexer having an input terminal and a plurality of output terminals, a second de-multiplexer having a input terminal and a plurality of output terminals, a first data line, a second data line, and a third data line. The first de-multiplexer and the second de-multiplexer are located at opposite side of the open area, the first de-multiplexer and the second de-multiplexer are connected to the data driver through a first data output terminal of the data driver, and the first de-multiplexer is located between the data driver and the open area. The first data line is connected to one of the output terminals of the first de-multiplexer, the second data line is connected to one of the output terminals of the second de-multiplexer, and the third data line is connected to the input terminal of the second de-multiplexer.

Other embodiments of the present disclosure will become more apparent from the following detailed description when taken in conjunction with the accompanying drawings.

### BRIEF DESCRIPTION OF THE DRAWINGS

FIG. 1 is a schematic diagram of a display panel in accordance with one embodiment;

FIG. 2 is a schematic diagram of a display panel in accordance with one embodiment;

FIG. 3A is a schematic diagram of a display panel in accordance with one embodiment;

FIG. 3B shows that the de-multiplexer circuits comprise six switches and five switches, respectively; FIG. 3C shows that the de-multiplexer circuits comprise n switches and n-1 switches, respectively;

FIGS. 4A and 4B schematically illustrate an operation and circuits of the de-multiplexers;

FIG. 5 is a schematic diagram of a display panel in accordance with one embodiment;

FIG. 6 shows the timing diagrams of the de-multiplexers; FIG. 7 is a schematic diagram of a display panel in accordance with one embodiment;

FIG. 8 shows the timing diagrams of the de-multiplexers ;

FIG. 9 is a schematic diagram of a display panel in accordance with one embodiment;

FIGS. 10A and 10B schematically illustrate an operation and circuits of the de-multiplexers;

FIG. 11 is a schematic diagram of a display panel in accordance with one embodiment; and

FIG. 12 shows the timing diagrams of the de-multiplexers.

### DETAILED DESCRIPTION OF THE PREFERRED EMBODIMENT

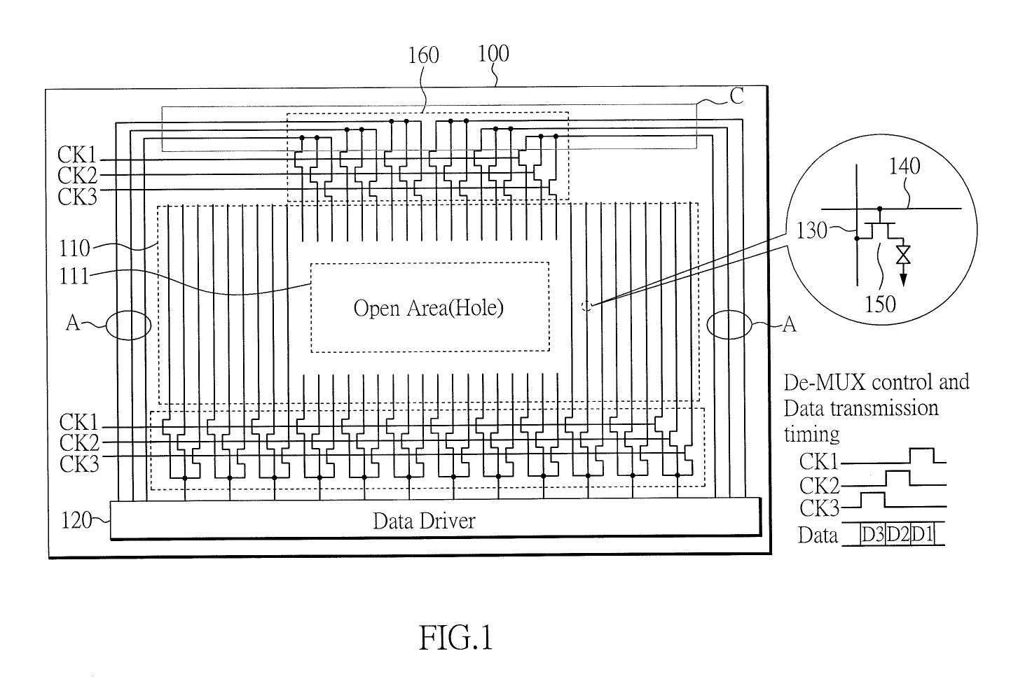

FIG. 1 is a schematic diagram of a display panel in accordance with one embodiment. As shown in FIG. 1, the perforated display panel includes plural data lines 130 and plural scan lines 140. The data line 130 is also known as a source line and the scan line 140 is also known as a gate line. The data line 130 is connected to sources of plural pixel TFTs 150 and the scan line 140 is connected to gates of plural pixel TFTs 150.

A perforated display 100 has an open area 111 within a display area (active area), particularly in the middle of display area 110. The data lines 130 are divided into two parts by the open area 111, which are respectively at near side and far side of the data driver 120. Because data lines 130 are split by the open area 111 in the perforated display 100, the perforated display 100 needs to have a means to transmit data signal to the data lines 130 at the far side of the data driver 120.

One direct method to input data signal to the data lines 130 at the far side of the data driver 120 is just to increase output pins of the data driver 120 and related wiring within a peripheral area of the display area 110, and connect the extra wiring to the data lines 130 at the far side of the data driver 120 via an extra de-multiplexer circuit 160 which is placed at the far side of the data driver 120 and comprises at least one de-multiplexer (De-MUX), wherein the extra wiring in the peripheral area is shown in the ellipse “A” and “C” in FIG. 1.

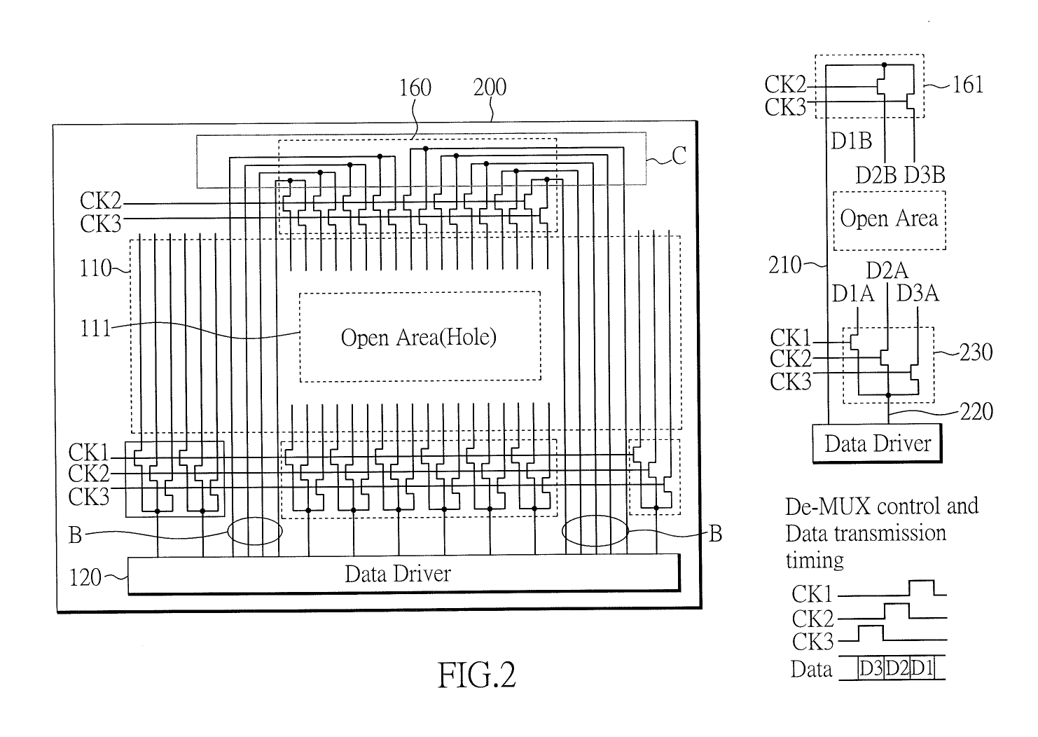

FIG. 2 is a schematic diagram of a display panel 200 in accordance with the other one embodiment. As shown in FIG. 2, to input data signal to the far side of the data driver 120 is to transmit the data signal to the data lines 130 at the far side via a data line 210 and a de-multiplexer 161, wherein the de-multiplexer 161 is placed at the far side of the data driver 120. The data line 210 is used to transmit the data signal to the data driver 120 at the far side, and the data line 210 is directly connected to output pin of the data driver 120. The data line 210 is independent of the data line 220, wherein the data line 220 is directly connected to the second de-multiplexer 230 at the near side of the data driver 120 and the output pin of the data driver 120. The extra wiring in the peripheral area is shown in the ellipse “B” and “C”.

In FIG. 2, the de-multiplexer 230 has three switches, wherein the input terminals of the three switches is connected to one output pin of the data driver 120 through the data line 220, the output terminals are connected to three individual data lines, and the control terminals of the three switches are connected to first control signal CK1, second control signal CK2 and third control signal CK3. The de-multiplexer 161 has two switches, wherein the input terminals of the two switches are connected to one output pin of the data driver 120 through the data line 210, the output terminals of the two switches are connected to two individual data lines, and the control terminals of the two switches are connected to second control signal CK2 and third control signal CK3. For de-multiplexer control and data transmission timing of the circuit, the control sequentially turned on and off from CK3 to CK1, and sequentially turned on and off the related switches, and data signals D1A, D2A, D3A, D1B, D2B, and D3B are supplied into related sub-pixels at dual sides of the open area 111.

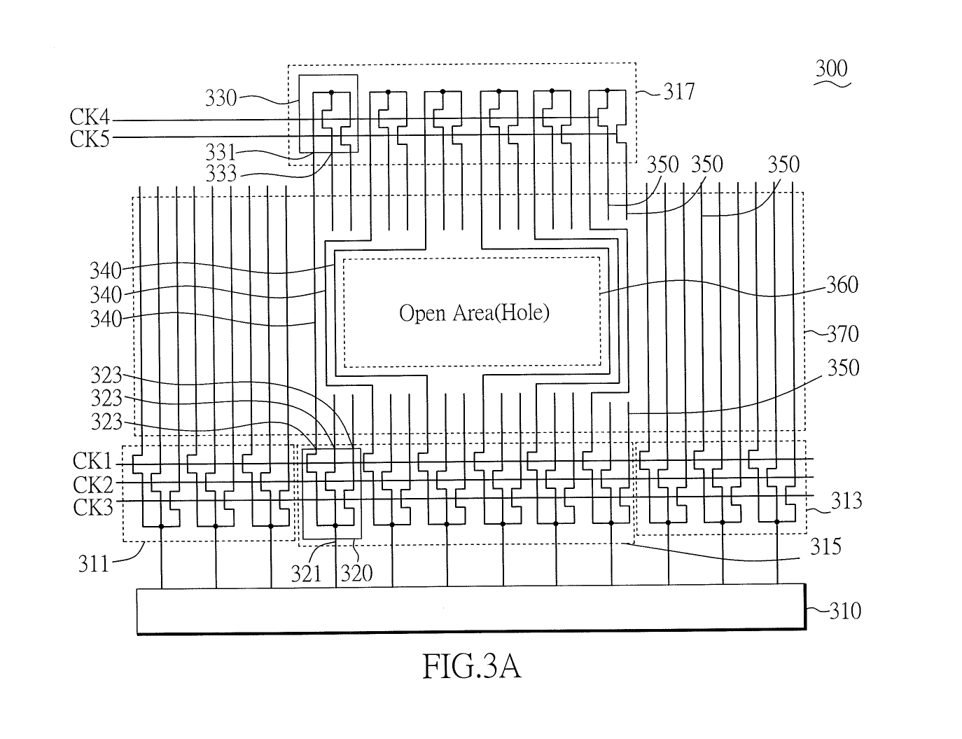

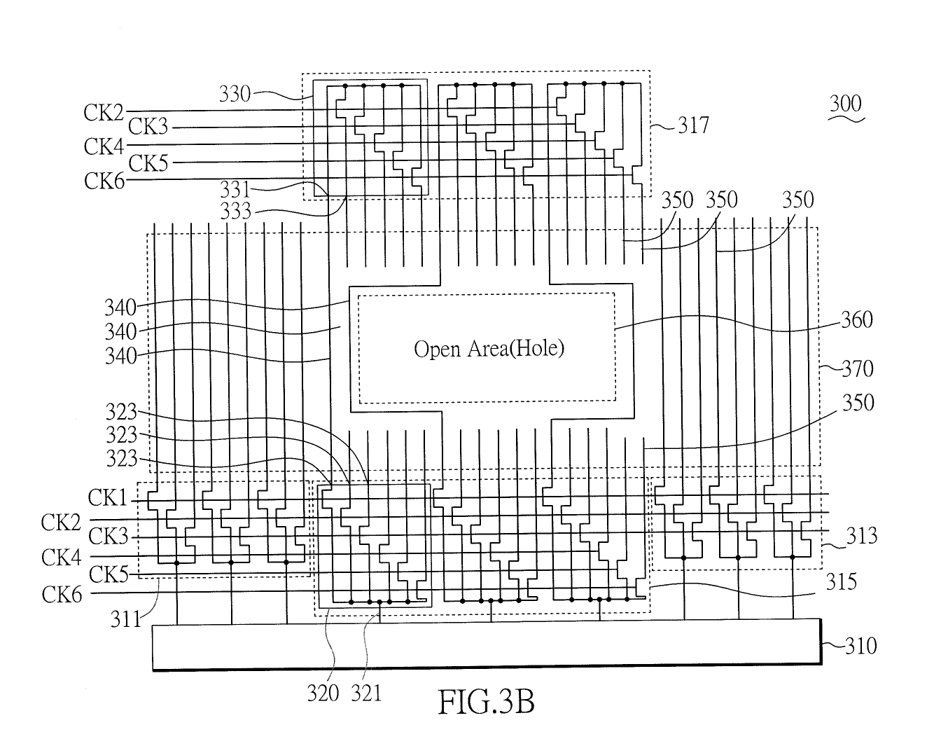

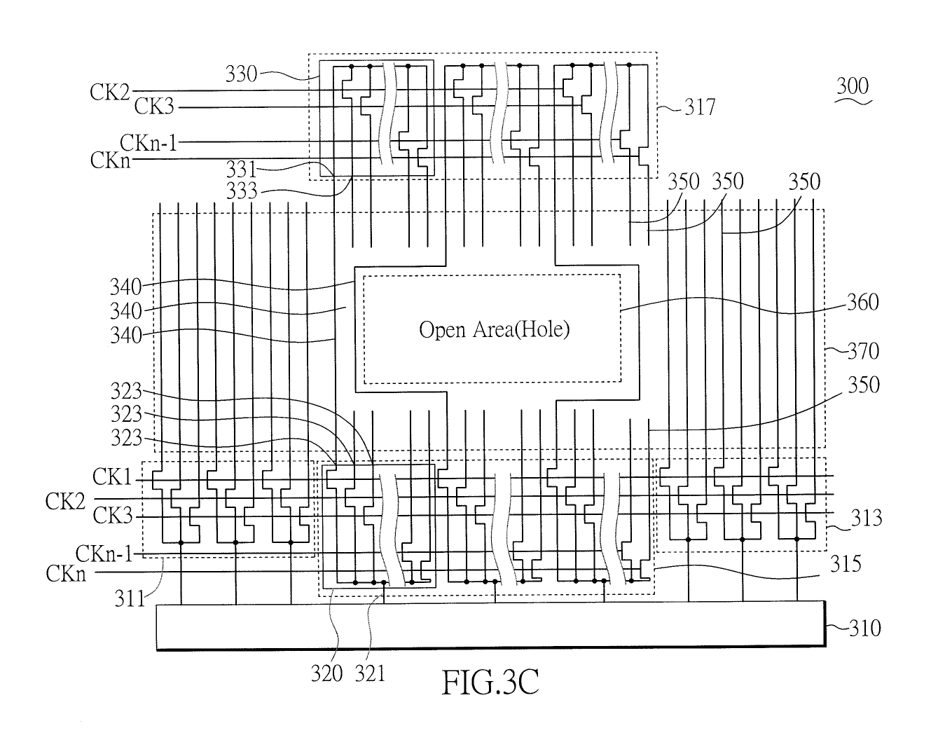

FIG. 3A is a schematic diagram of a display panel in accordance with the other one embodiment. The display panel 300 includes at least one data driver 310, a plurality of ordinary de-multiplexer circuits 311 and 313, a plurality of extra-ordinary de-multiplexer circuits 315 and 317, at least one first data line 340, and a plurality of second data lines 350.

The data driver 310 comprises a plurality of data output terminals (pins) connected to de-multiplexer circuits for supplying data signals to sub-pixels within the display area 370. The de-multiplexer circuits 311 and 313 comprise at least one de-multiplexer (De-MUX) with switches controlled by a plurality of control lines and transmit data signals through the second data lines 350. In this embodiment, the de-multiplexer circuits 311 and 313 comprise three switches controlled by three control lines CK1, CK2 and CK3. The input terminals of the switches are connected to the data driver 310 by one data line, and the output terminals of the switches are connected to related sub-pixels by individual second data lines 350. In other embodiments, the de-multiplexer could comprise 2, 4, 5, 6, 7, 8, 9, 10, 11, 12 . . . , or other integer numbers of second data lines 350 and corresponding switches and control lines.

The de-multiplexer circuits 315 and 317 are located at opposite sides of the open area 360, and the de-multiplexer circuit 315 is adjacent to the data driver 310 and the de-multiplexer circuits 311 and 313. The de-multiplexer circuit 315 comprises at least one de-multiplexer 320. In this embodiment, the de-multiplexer 320 comprises three switches respectively controlled by three control lines CK1, CK2 and CK3, the input terminal 321 of the switches is connected to the data driver 310 by one data line, and the output terminals 323 of the switches are connected to related sub-pixels by two second data lines 350 and one first data line 340. The de-multiplexer circuit 317 comprises at least one de-multiplexer 330. In this embodiment, the de-multiplexer 330 comprises two switches respectively controlled by two control lines CK4 and CK5, the input terminal 331 of the switches is connected to one of the switches of the de-multiplexer 320 by the first data line 340, and the output terminals 333 of the switches are connected to related sub-pixels by two second data lines 350. The lengths of the first data lines 340 of the de-multiplexers in the de-multiplexer circuit 317 may be different and the first data lines 340 may split into two ways surrounding the open area 360. The number of sub-pixels on the second data lines 350 of the de-multiplexer circuits 311 and 313 is more that of the sub-pixels on the second data lines 350 of the de-multiplexer circuits 315 and 317. In other embodiments, the de-multiplexer could comprise 2, 4, 5, 6, 7, 8, 9, 10, 11, 12 . . . , or other integer numbers of switches and corresponding second data lines 350 and control lines. As shown in FIG. 3B, the de-multiplexer circuits 315 and 317 comprise six switches and five switches, respectively. As shown in FIG. 3C, the de-multiplexer circuits 315 and 317 comprise n switches and n-1 switches, respectively.

In this embodiment, the number of difference in the switches and the control lines CK between the de-multiplexer 320 and the de-multiplexer 330 is one. In other embodiments, the number of difference could be other integers. In this embodiment, the number of difference in the output terminals between the de-multiplexer 320 and the de-multiplexer 330 is one. In other embodiments, the difference could be other integers.

The data line 340 is connected between the output terminal 323 of the de-multiplexer 320 and the input terminal 333 of the de-multiplexer 330. The first data line 340 is provided for supplying data signal to corresponding column of sub-pixels and relaying data signal for another partial column of sub-pixels through the second data lines 350 of the de-multiplexer 330. The number of sub-pixels corresponding to the first data line 340 is more than the number of sub-pixels corresponding to the second data line 350 corresponding to the de-multiplexer circuits 315 and 317. The direction of the second data lines 350 connected to the output terminals 323 of the de-multiplexer 320 is opposite to the direction of the second data lines 350 connected to the output terminals 333 of the de-multiplexer 330.

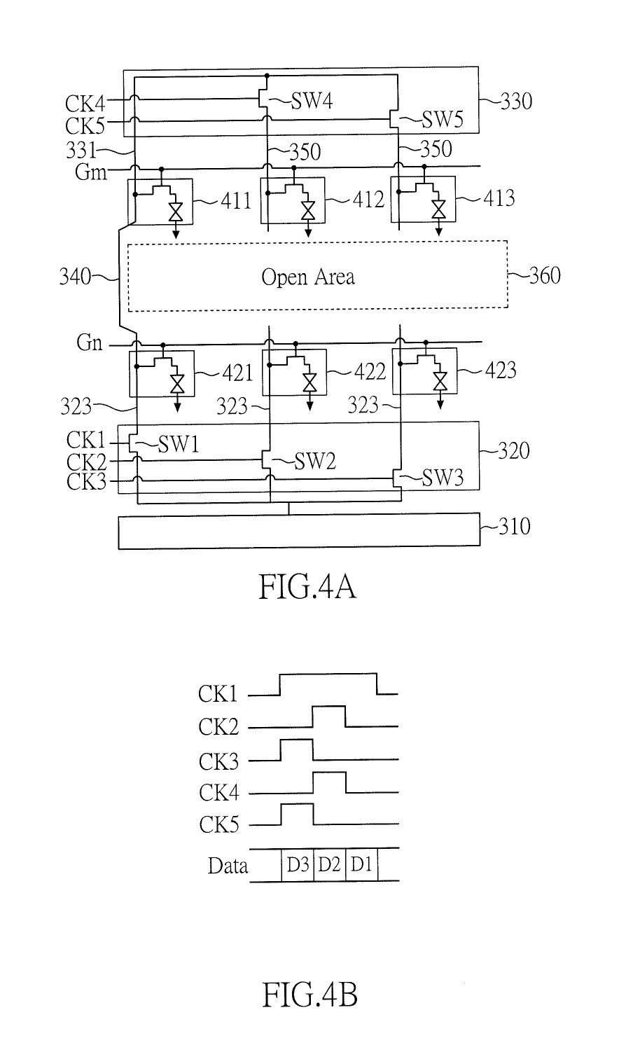

In this embodiment, the display panel 300 is a perforated display panel which has an open area 360 within a display area 370, particularly in the middle of the display area 370. FIGS. 4A and 4B schematically illustrate an operation and circuits of the de-multiplexer 320 and the de-multiplexer 330 according to the present disclosure.

As shown in FIG. 4A, the de-multiplexer 320 includes a switch SW1, a switch SW2 and a switch SW3, and the de-multiplexer 330 includes a switch SW4 and a switch SW5.

An output terminal 323 of the switch SW1 is connected to an input terminal 331 of the switch SW4 and the switch SW5 through a data line 340. In other embodiment, the first data line 340 could be selectively connected to the output terminal 323 of switch SW2 or switch SW3.

A control terminal of the switch SW1 is coupled to a clock signal CK1 to selectively provide the output terminal 323 of the switch SW1 with data signal from the data driver 310. A control terminal of the switch SW2 is coupled to a clock signal CK2 to selectively provide data signal from the data driver 310. A control terminal of the switch SW3 is coupled to a clock signal CK3 to selectively provide data signal from the data driver 310.

A control terminal of the switch SW4 is coupled to a clock signal CK4 to selectively provide data signal from the data driver 310 through the first data line 340. A control terminal of the switch SW5 is coupled to a clock signal CK5 to selectively provide data signal from the data driver 310 through the first data line 340.

As shown in FIGS. 4A and 4B, in the upper side scan period, the gate line Gm is on a high state. Thus, the gate of the TFTs of the sub-pixels 411, 412 and 413 is also on the high state, and the sub-pixels 411, 412 and 413 are ready for writing data signals. The switch SW1 is coupled to the clock signal CK1 to selectively provide one of a plurality of output nodes 323 with a data signal D3 from the data driver 310. That is, the data signal 3 outputted from the data driver 310 can be transmitted to the input terminal 331 of de-multiplexer 330 through the first data line 340. Therefore, when the clock signal CK1 is on the high state, the clock signal CK5 is on the high state, and the clock signal CK4 is on a low state, the data signal D3 will be written into the sub-pixels 411 and 413. Next, when the clock signal CK1 is on the high state, the clock signal CK4 is on the high state, and the clock signal CK5 is on the low state, the data signal D2 will be written into the sub-pixels 411 and 412. Finally, when the clock signal CK4 and the clock signal CK5 are on the low state and the clock signal CK1 is on the high state, the data signal D1 will be written into the sub-pixel 411. In this embodiment, switches and TFTs are NMOS, the turn-on voltage of the channel is high state and the turn-off voltage of the channel is low state. In other embodiment, switches and TFTs are PMOS, the turn-on voltage of the channel is low state, and the turn-on voltage of the channel is high state. In the lower side scan period, the gate line Gn is in the high state.

Thus, the gates of the sub-pixel 421, 422 and 423 are also on the high state, and the sub-pixels 421, 422 and 423 are ready for writing data signals. When the clock signal CK1 and the clock signal CK3 are on the high state, and the clock signal CK2 is on the low state, the data signal D3 will be written into the sub-pixel 421 and 423. Next, when the clock signal CK1 and the clock signal CK2 are on the high state, and the clock signal CK3 is on low state, the data signal D2 will be written into the sub-pixel 421 and 422. Finally, when the clock signal CK3 and the clock signal CK2 are not on the high state, and the clock signal CK1 is on the high state, the data signal D1 will be written into the sub-pixel 421. The clock signal CK2 is synchronous with the clock signal CK4, and the clock signal CK3 is synchronous with the clock signal CK5.

As shown in FIG. 3 and FIG. 4A, the first data line 340 is a bridge line which is placed around an open area 360. Data signal for the plurality of second data lines 350 of the open area 360 is transmitted through the data line 340 and the de-multiplexer 330. The control and data transfer timing of de-multiplexer 320 and the de-multiplexer 330 is shown in FIG. 4A and FIG. 4B. The advantages of this embodiment include less wiring space on panel peripheral area and the order of data signals output being the same as that in the non-perforated (no open area) display case.

As shown in FIG. 4B, the clock signal CK1 is on a high state while the clock signal CK2 and the clock signal CK4 are on the high state, and a time period of the high state for the clock signal CK1 is longer than the time period of the high state for the clock signal CK2 and the clock signal CK4. The clock signal CK1 is on a high state while the clock signal CK3 and the clock signal CK5 are on the high state, and a time period of the high state for the clock signal CK1 is longer than the time period of the high state for the clock signal CK3 and the clock signal CK6.

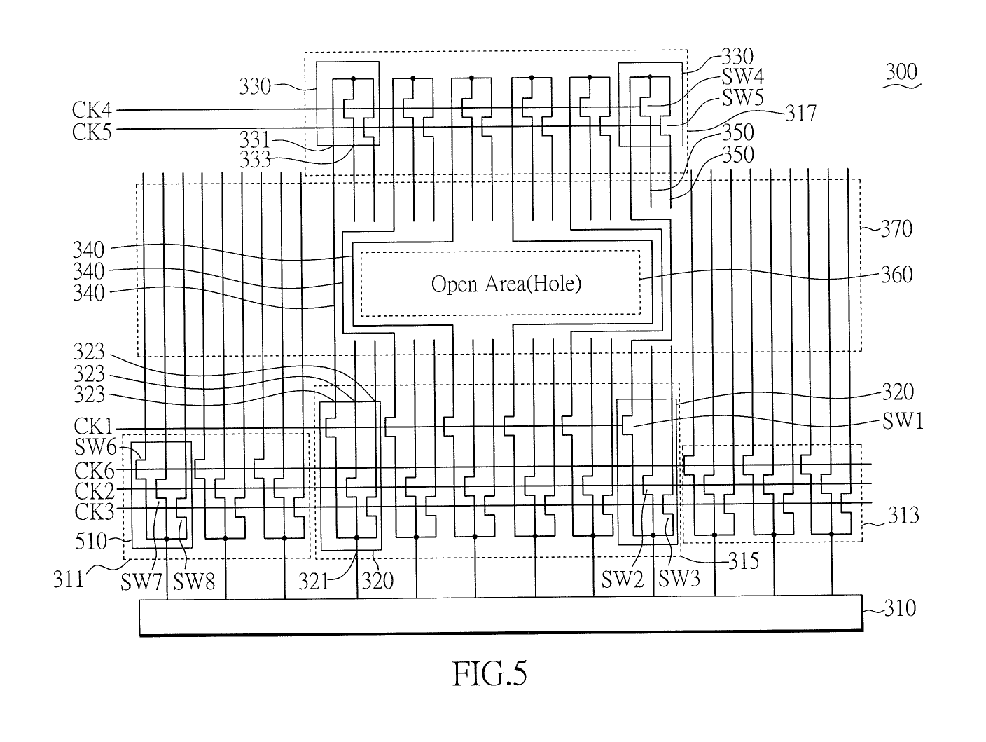

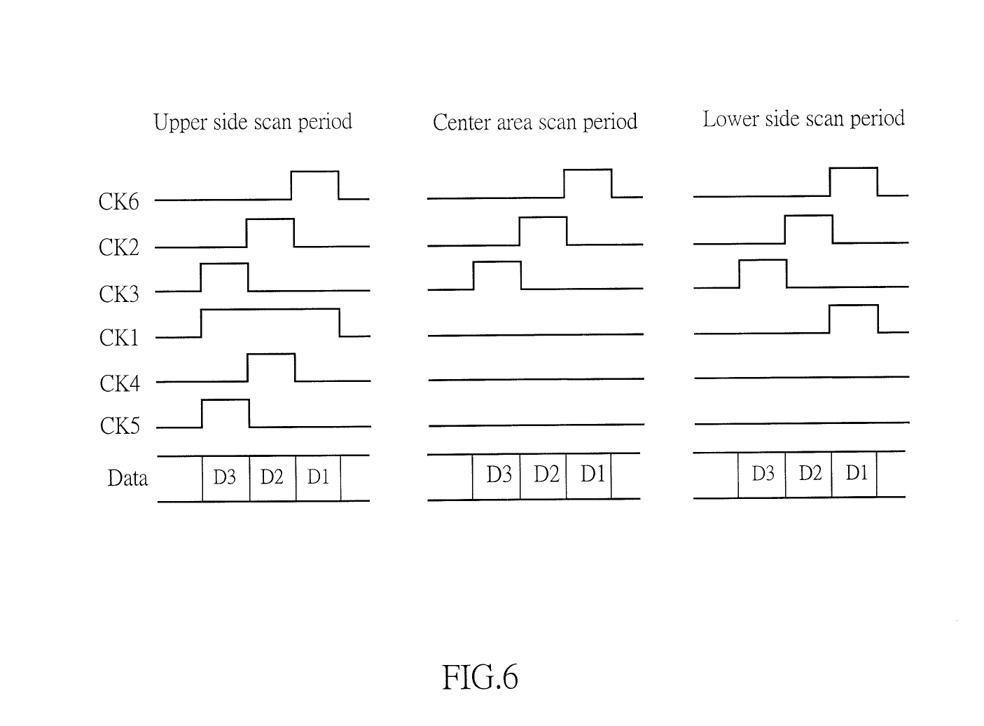

FIG. 5 is a schematic diagram of a display panel in accordance with the other one embodiment. In addition to the components in FIG. 3, the display panel 300 further includes at least a de-multiplexer 510 within the de-multiplexer circuit 311. The de-multiplexer 510 has a switch SW6, a switch SW7, and a switch SW8. The switch SW6 is coupled to a clock signal CK6 to selectively provide data signal from the data driver 310. The switch SW7 is coupled to the clock signal CK2 to selectively provide data signal from the data driver 310. The switch SW8 is coupled to the clock signal CK3 to selectively provide data signal from the data driver 310. FIG. 6 shows the timing diagrams of the de-multiplexer 320, the de-multiplexer 330, and the de-multiplexer 510.

As shown in FIG. 6, the independent control of the de-multiplexer 320, the de-multiplexer 330, and the de-multiplexer 510 can reduce power consumption. During the upper side scan period, the clock signal CK1 is kept on the high state “H” during data transmission of D3, D2 and D1, and the clock signal CK4 and the clock signal CK5 are toggled to be the same as the clock signal CK2 and the clock signal CK3.

During the center area (open area rows) scan period, the clock signal CK1, the clock signal CK4 and the clock signal CK5 are kept on the low state “L”. During lower side scan period, the clock signal CK4 and the clock signal CK5 are kept in the low state “L”, and the clock signal CK1 is toggled to be the same as the clock signal CK6. By comparing FIG. 4B with FIG. 6, it is known that the clock signal CK1 is not necessary to be always in the high state “H” during the center area (open area rows) scan period and the lower side scan period, so as to save more power.

FIG. 7 is a schematic diagram of a display panel in accordance with the other one embodiment. As shown in FIG. 7, the switch SW6 is coupled to a clock signal CK6 to selectively provide data signal from the data driver 310. The switch SW7 is coupled to a clock signal CK7 to selectively provide data signal from the data driver 310. The switch SW8 is coupled to an clock signal CK8 to selectively provide data signal from the data driver 310.

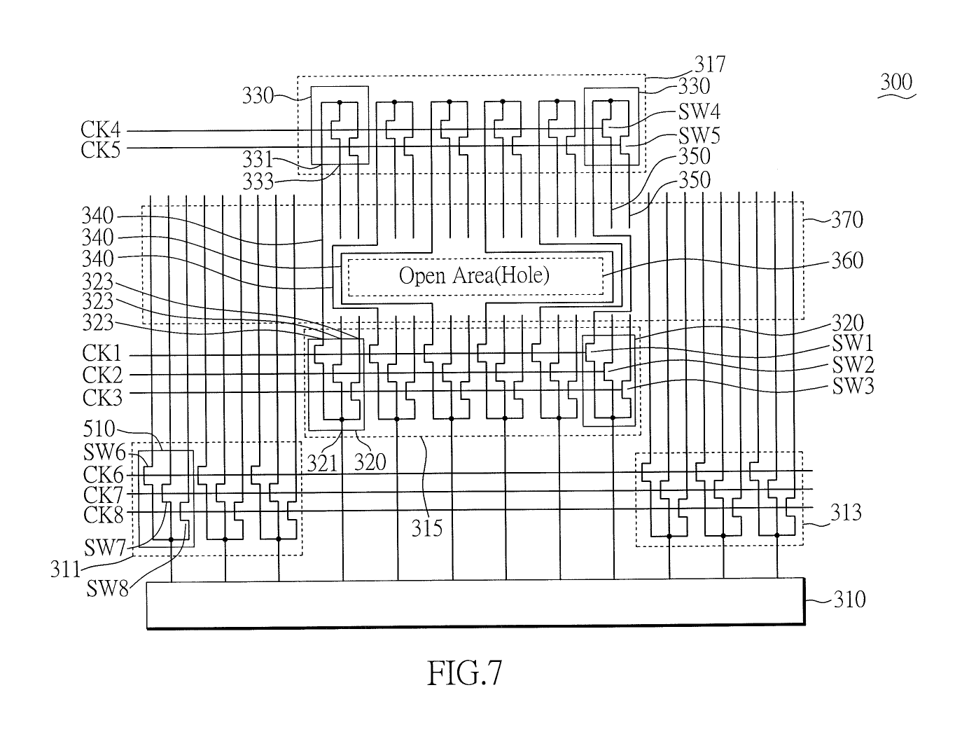

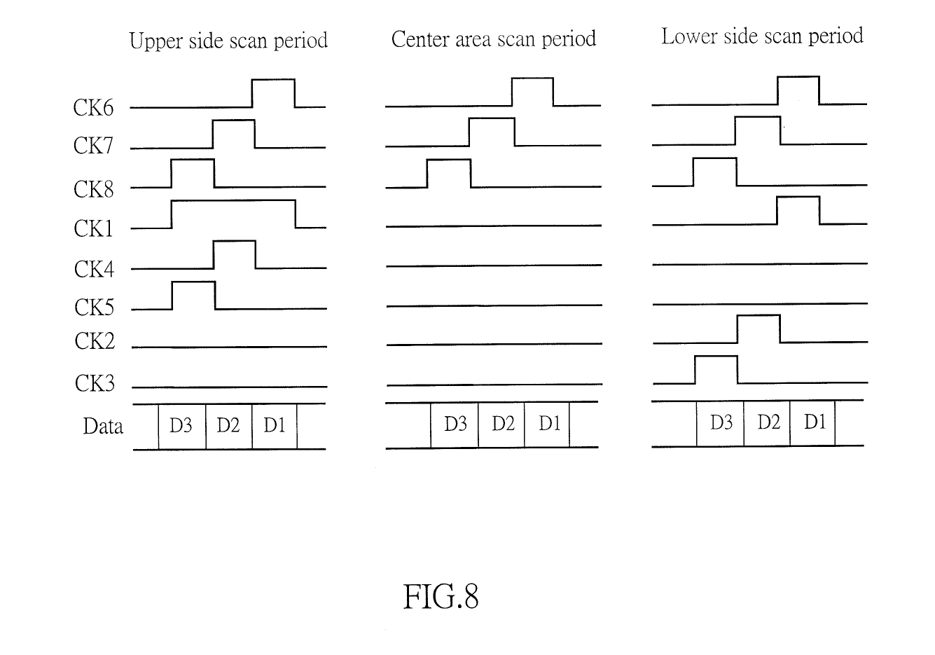

FIG. 8 shows the timing diagrams of the de-multiplexer 320, the de-multiplexer 330, and the de-multiplexer 510.

As shown in FIG. 8, the independent control of the de-multiplexer 320, the de-multiplexer 330, and the de-multiplexer 510 can reduce power consumption. During the upper side scan period, the clock signal CK1 is kept on the high state “H” during data transmission of D3, D2 and D1, the clock signal CK4 and the clock signal CK5 are toggled to be the same as the clock signal CK7 and the clock signal CK8, and the clock signal CK2 and the clock signal CK3 are kept on the low state “L”.

During the center area (open area rows) scan period, the clock signal CK1, the clock signal CK4, the clock signal CK5, the clock signal CK2 and the clock signal CK3 are kept on the low state “L”.

During the lower side scan period, the clock signal CK1 is toggled to be the same as the clock signal CK6, the clock signal CK2 is toggled to be the same as the clock signal CK7, and the clock signal CK3 is toggled to be the same as the clock signal CK8. The clock signal CK4 and the clock signal CK5 are kept on the low state “L”.

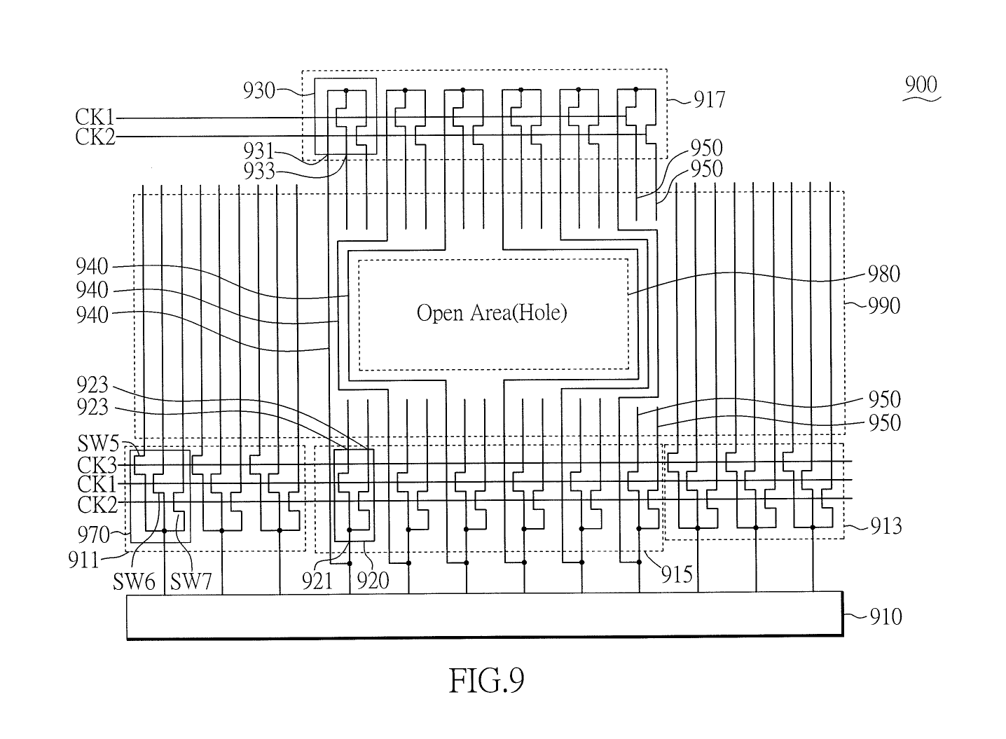

FIG. 9 is a schematic diagram of a display panel in accordance with the other one embodiment. The display panel 900 includes a data driver 910, at least one de-multiplexer 920, at least one de-multiplexer 930, at least one first data line 940, a plurality of second data lines 950, a plurality of control lines CK, and at least a de-multiplexer 970.

The de-multiplexer 920 has an input terminal 921 connected to an output pin of the data driver 910, and a plurality of output terminals 923 connect to the second data lines 950. The at least de-multiplexer 930 has an input terminal 931 connect to the output pine of the data driver 910, and a plurality of output terminals 933 connect to the second data lines 950.

The first data line 940 is connected between the input terminal 931 of the de-multiplexer 930 and the same output pin to which the input terminal 921 is connected. The first data lines 940 and the second data lines 950 are for supplying data signal for corresponding columns of sub-pixels. The first data lines 940 are also for relay data signal for another columns of sub-pixels.

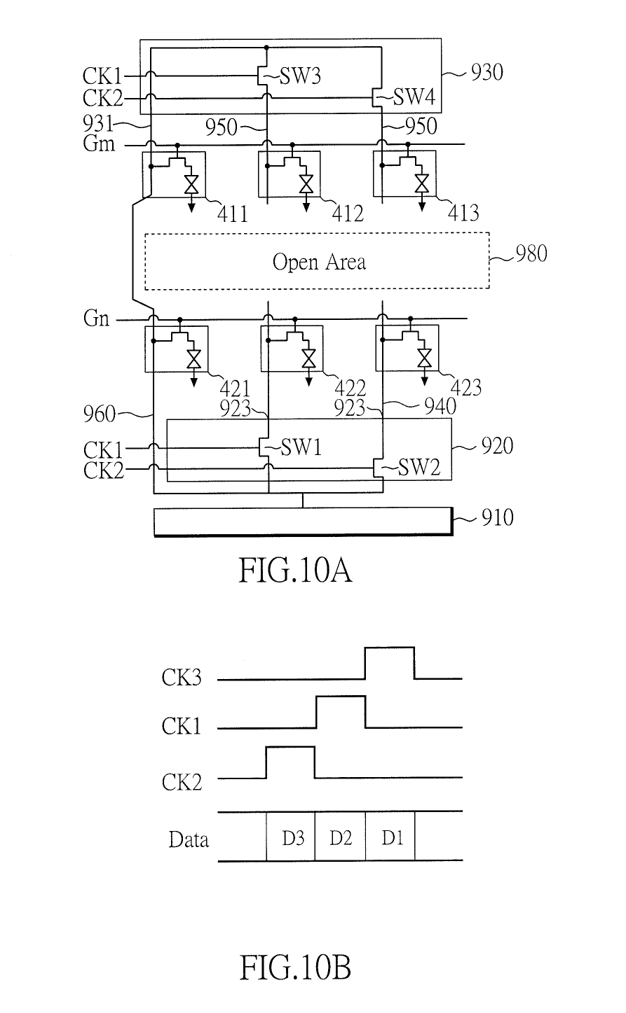

In this embodiment, the display panel 900 is a perforated display panel which has an open area 980 within a display area 990. FIGS. 10A and 10B schematically illustrate an operation and circuits of the de-multiplexer 920, the de-multiplexer 930, and the de-multiplexer 970.

In FIG. 10A, the de-multiplexer 920 includes a switch SW1 and a switch SW2, and the de-multiplexer 930 includes a switch SW3 and a switch SW4. With reference to FIG. 9, the de-multiplexer 970 has a switch SW5, a switch SW6, and a switch SW7.

The switch SW1 is coupled to a clock signal CK1 to selectively provide data signal from the data driver 910. The switch SW2 is coupled to a clock signal CK2 to selectively provide data signal from the data driver 910. The switch SW3 is coupled to the clock signal CK1 to selectively provide data signal from the data driver 910 through the first data line 940, and the switch SW4 is coupled to the clock signal CK2 to selectively provide data signal from the data driver 910 through the first data line 940.

The switch SW5 is coupled to a clock signal CK3 to selectively provide data signal from the data driver 910. The switch SW6 is coupled to the clock signal CK1 to selectively provide data signal from the data driver 910. The switch SW7 is coupled to the clock signal CK2 to selectively provide data signal from the data driver 910.

In comparison with the aforementioned examples, one of the switches in the de-multiplexer 920 can be removed so as to reduce the hardware cost. In this case, with reference to FIG. 10B, the timing of de-multiplexer control signals (CK1, CK2, and CK3) can be sequentially scanned.

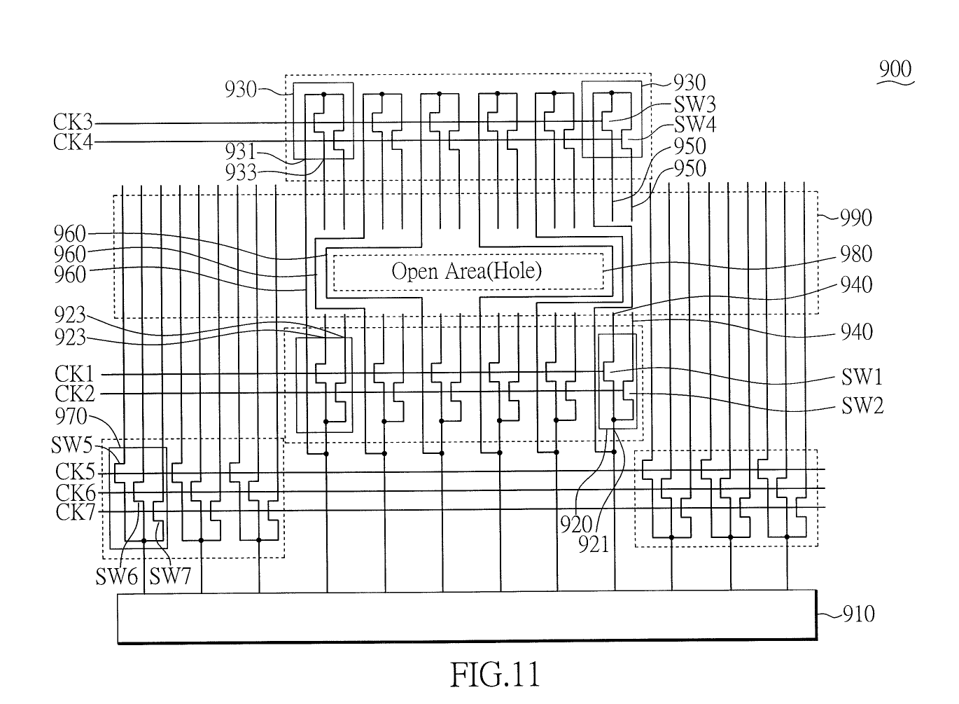

FIG. 11 is a schematic diagram of a display panel in accordance with the other one embodiment. As shown in FIG. 11, the switch SW1 is coupled to a clock signal CK1 to selectively provide data signal from the data driver 910. The switch SW2 is coupled to a clock signal CK2 to selectively provide data signal from the data driver 910. The switch SW3 is coupled to a clock signal CK3 to selectively provide data signal from the data driver 910 through the first data line 940. The switch SW4 is coupled to a clock signal CK4 to selectively provide data signal from the data driver 910 through the first data line 940.

The switch SW5 is coupled to a clock signal CK5 to selectively provide data signal from the data driver 910. The switch SW6 is coupled to a clock signal CK6 to selectively provide data signal from the data driver 910. The switch SW7 is coupled to a clock signal CK7 to selectively provide data signal from the data driver 910.

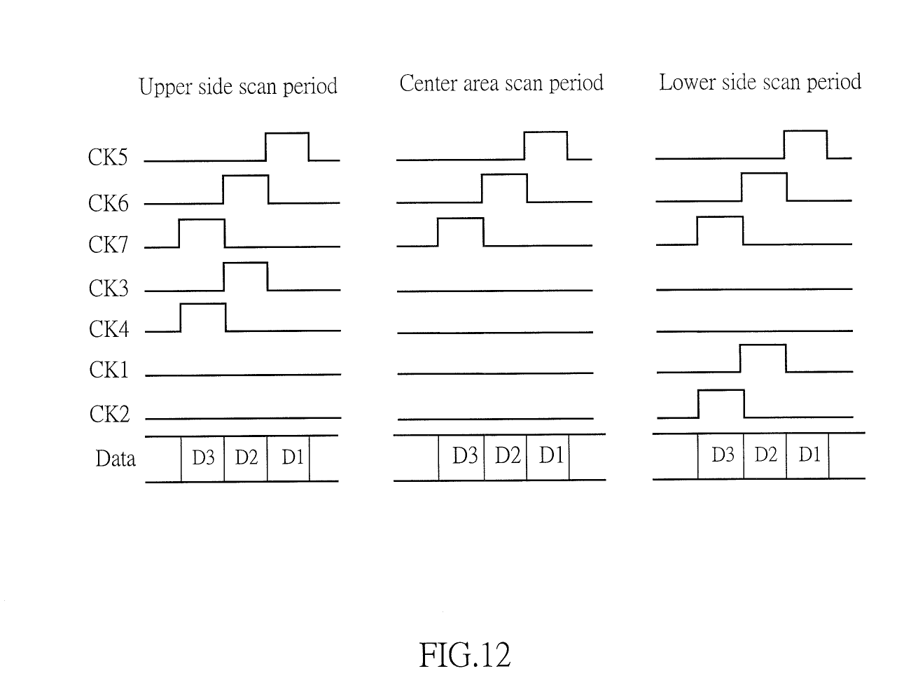

FIG. 12 shows the timing diagrams of the de-multiplexer 920, the de-multiplexer 930, and the de-multiplexer 970.

As shown in FIG. 12, the independent control of the de-multiplexer 920, the de-multiplexer 930, and the de-multiplexer 970 can reduce power consumption.

During the upper side scan period, the clock signal CK1 and the clock signal CK2 are kept on the low state “L”, the clock signal CK3 is toggled to be the same as the clock signal CK6, and the clock signal CK4 is toggled to be the same as the clock signal CK7.

During the center area (open area rows) scan period, the clock signal CK3, the clock signal CK4, the clock signal CK1 and the clock signal CK2 are kept on the low state “L”.

During the lower side scan period, the clock signal CK3 and the clock signal CK4 are kept on the low state “L”, the clock signal CK1 is toggled to be the same as the clock signal CK6, and the clock signal CK2 is toggled to be the same as the clock signal CK7

By employing the independent clock signals for each de-multiplexer, clock signal driving power and data driver loading can be effectively reduced according to the scan area.

As cited, using of the bridge lines (BDLs) wired around the display open area. The bridge lines can be data transmission lines for the de-multiplexer 330 which is located at the far side of the data driver 310 in a perforated display device. With the technology, wiring space impact on the panel peripheral area can be eliminated, and the order of data signal output and output number of data driver can be the same as that in the non-perforated display, thereby providing a narrow-border display panel.

Although the present disclosure has been explained in relation to its various embodiments, it is to be understood that many other possible modifications and variations can be made without departing from the spirit and scope of the invention as hereinafter claimed.

What is claimed is:

1. A display panel, comprising:
an open area;
a data driver;
a first de-multiplexer having an input terminal and a plurality of output terminals;
a second de-multiplexer having an input terminal and a plurality of output terminals;
a first data line;
a second data line; and
a third data line;
wherein the first de-multiplexer and the second de-multiplexer are located at opposite side of the open area, the first de-multiplexer and the second de-multiplexer are connected to the data driver through a first data output terminal of the data driver, and the first de-multiplexer is located between the data driver and the open area;
wherein the first data line is connected to one of the output terminals of the first de-multiplexer, the second data line is connected to one of the output terminals of the second de-multiplexer, and the third data line is connected to the input terminal of the second de-multiplexer.

2. The display panel as claimed in claim 1, wherein the third data line is connected to the other one of the output terminals of the first de-multiplexer.

3. The display panel as claimed in claim 2, wherein the first de-multiplexer includes a first switch and a third switch, the second de-multiplexer includes a second switch, the first switch is connected to the first data line and the first data output terminal, the second switch is connected to the second data line and the third data line, and the third switch is connected to the third data line and the first data output terminal.

4. The display panel as claimed in claim 3, wherein the first switch is coupled to a first clock signal, the second switch is coupled to a second clock signal, and the third switch is coupled to a third clock signal.

5. The display panel as claimed in claim 4, wherein the first clock signal is synchronous with the second clock signal.

6. The display panel as claimed in claim 5, wherein the third clock signal is on a high state while the first clock signal and the second clock signal are on the high state, and a time period of the high state for the third clock signal is more than the time period of the high state for the first clock signal and the second clock signal.

7. The display panel as claimed in claim 6, wherein a first data signal is inputted into the first data line, second data line, and the third data line while the first clock signal, the second clock signal, and the third clock signal are on the high state, and a second data signal is inputted into the third data line while the third clock signal is on the high state.

8. The display panel as claimed in claim 1, further comprising a plurality of sub-pixels are connected to the first data line, a plurality of sub-pixels are connected to the second data line, and a plurality of sub-pixels are connected to the third data line.

9. The display panel as claimed in claim 8, wherein the number of the sub-pixels for the third data line is more than the number of the sub-pixels for the first data line and the sub-pixels for the second data line.

10. The display panel as claimed in claim 4, further comprising a third de-multiplexer includes a fourth switch and a fifth switch, the fourth switch is connected to a fourth data line and a second data output terminal of the data driver, and the fifth switch is connected to a fifth data line and the second data output terminal of the data driver.

11. The display panel as claimed in claim 10, wherein the fourth switch is coupled to the third clock signal and the fifth switch is coupled to the first clock signal.

12. The display panel as claimed in claim 10, wherein the fourth switch is coupled to a fourth clock signal and the fifth switch is coupled to the first clock signal.

13. The display panel as claimed in claim 10, wherein the fourth switch is coupled to a fourth clock signal and the fifth switch is coupled to a fifth clock signal.

14. The display panel as claimed in claim 1, wherein the third data line is connected to the input terminal of the first de-multiplexer and the first data output terminal.

15. The display panel as claimed in claim 14, wherein the first de-multiplexer includes a first switch, the second de-multiplexer includes a second switch, the first switch is connected to the first data line and the first data output terminal, and the second switch is connected to the second data line and the first data output terminal.

16. The display panel as claimed in claim 15, wherein the first switch is coupled to a first clock signal, and the second switch is coupled to a second clock signal.

17. The display panel as claimed in claim 16, further comprising a third de-multiplexer includes a third switch, the third switch is connected to a fourth data line and a second data output terminal of the data driver.

18. The display panel as claimed in claim 16, wherein the third switch is coupled to the first clock signal.

19. The display panel as claimed in claim 16, wherein the third switch is coupled to a third clock signal.
